(19) United States
(12) Patent Application Publication
(10) Pub. No.: US 2005/0137889 A1
(43) Pub. Date: Jun. 23, 2005

(54) Remotely binding data to a user device

(76) Inventor: David M. Wheeler, Gilbert, AZ (US)

Correspondence Address: TROP PRUNER & HU, PC, 8554 KATY FREEWAY, SUITE 100, HOUSTON, TX, 77024, US

(21) Appl. No.: 10/740,306

(22) Filed: Dec. 18, 2003

(51) Int. Cl. G06F 17/60

(52) U.S. Cl. 705/1

(57) ABSTRACT

In one embodiment, the present invention includes a method for binding a token to a device, and preventing a user of the device from unauthorized access to the token. The token may be an electronic ticket obtained from a remote source, in certain embodiments.

### BACKGROUND

Often in the physical world, people carry objects that give permissions, but they do not have the ability or authority to modify or duplicate the permissions. In some cases, there is not even an ability to examine the contents of these objects, nor are individuals aware of (nor care) about the contents. Examples include a subscriber identity module (SIM) card used in a cellular telephone, or a magnetic stripe on subway tickets. These objects act as tickets that grant access, in one case to a cellular network, in the other case to a subway.

In the digital world, it is convenient to be able to construct these types of objects for use. Several cryptographic techniques have been used to create non-forgeable tokens. Such tokens are used in certain computing platforms to limit access of the platform to a given user. A need exists to remotely bind data such as a token to a user device while preventing improper access to the token, even by the device user.

### BRIEF DESCRIPTION OF THE DRAWINGS

FIG. 1 is a flow diagram of a method in accordance with one embodiment of the present invention.

FIG. 2 is a flow diagram of an electronic ticket generation method in accordance with one embodiment of the present invention.

FIG. 3 is a flow diagram of an electronic ticket redemption method in accordance with one embodiment of the present invention.

FIG. 4 is a block diagram of a system in accordance with one embodiment of the present invention.

### DETAILED DESCRIPTION

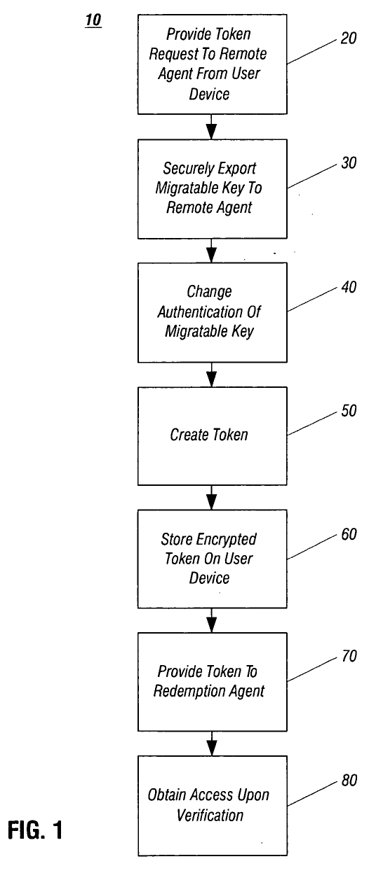

Referring to FIG. 1, shown is a flow diagram of a method in accordance with one embodiment of the present invention. As shown in FIG. 1, method 10 may begin by providing a token request to a remote agent from a user device (block 20). Such a request may be for an electronic ticket, as an example. Alternately, such a request may be for software or services, such as an application program, digital content, and the like. As used herein “token” means any electronic data (i.e., data and/or instructions) to which access may be limited by means of a combination of hardware and software.

A remote agent may be a ticket granting agent, in one embodiment. Alternately, a remote agent may be a rights management agent. Such a ticket granting agent may be an agent associated with an activity or facility to which a ticket or other authorization is needed for access, such as a sporting event, movie, play, digital content usage, airplane flight, or any other such facility or activity. As used herein, “activity” is used broadly to refer to any event, procedure, pursuit, transportation, mechanism, usage, facility and the like.

In various embodiments, the request may be provided from a user device. While such a user device may vary in different embodiments, in certain embodiments, a user device may be a mobile device such as a third generation (3G) cellular telephone. Alternately, the user device may be a personal digital assistant (PDA), a portable computer or the like. In other embodiments the user device may be a personal computer, server computer, set-top box, and the like. The request may be sent in one of a variety of protocols such as Internet Protocol (IP), Transmission Control Protocol/Internet Protocol (TCP/IP), Extensible Markup Language (XML), or the like.

In various embodiments, the user device may include a Trusted Platform Module (TPM) in accordance with the Trusted Computing Platform Alliance (TCPA) Main Specification Version 1.1b, published Feb. 22, 2002 (the “TCPA specification”). Alternately, another such trusted or secure module may be included in a user device.

As used herein, the term “TCPA TPM” refers to protocols and activities associated with one or more TCPA specifications, while the term “TPM” refers generically to a trusted or secure module. Using such a TPM, reliable information may be provided about itself and its current hardware and software processes, and provide attestation to operation of its processes.

In one embodiment, the TPM may be embedded in the user device, and the user of the device has access to a storage root key (SRK), at least one attestation identity key (AIK), and a personal storage key (i.e., a user's key).

Next, a migratable key (e.g., a storage key) may be securely exported to the remote agent (block 30). Such a migratable key may be, for example, a wrap key created in accordance with TCPA TPM commands. The key may be extracted securely in a migratable blob and shipped to the remote agent.

Upon receipt of the migratable key, a ticket granting agent may change the authentication value of the migratable key in a secure manner (block 40). Then the remote agent may create a token using the key it received from the user device through migration (block 50).

This token may be encrypted and sent to the user device for storage in an encrypted manner (block 60). Via such encryption, the token may be bound to the user device and remain protected from modification, duplication, and other unauthorized access. In such manner a device user may thus give control over a portion of the device (i.e., the token) to a third party.

At a later time, when a user of the device desires to redeem the token for access to a desired activity, the user may provide the encrypted token to a redemption agent (block 70). Such a redemption agent may be an agent associated with the activity or facility, and may be the same or different entity than the remote granting agent discussed above. When the redemption agent verifies the encrypted token, the user may be provided access to the activity or facility (block 80).

While discussed above as relating to electronic tickets, it is to be understood that in other embodiments, a token may be created and used for other secure purposes, such as access to secure locations, electronic devices or secure storage contained therein. For example, using an embodiment of the present invention, digital content securely stored on a user device (pursuant to a user request) may be accessed by the user. Such digital content may be, for example, distributed software, digital content, such as movies, programming, music, electronic books, and the like.

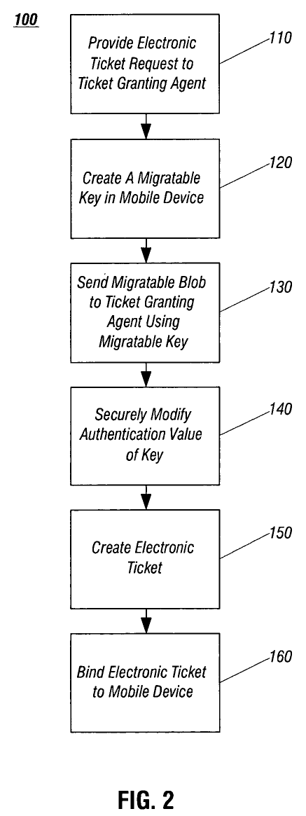

Referring now to FIG. 2, shown is a flow diagram of an electronic ticket generation method in accordance with one embodiment of the present invention. As shown in FIG. 2, method 100 begins by providing an electronic ticket request to a ticket granting agent (block 110). Such a request may be generated by a mobile device, such as a 3G cellular phone, a PDA, a portable computer and the like. In one embodiment, the remote ticketing agent may be a remote server accessible via the Internet.

Next, a migratable key may be created in the mobile device (block 120). In one embodiment, such a migratable key may be created in accordance with commands in compliance with TCPA TPM specifications (“TCPA TPM commands”). For example, a TPM_CreateWrapKey command may be used. This ticket key may be a storage key, encrypted using Rivest Shamir Adelman (RSA) or Advanced Encryption Standard (AES) cryptographic algorithms, in certain embodiments. The migratable key may be sent to a ticket granting agent via a migratable blob generated by the mobile device (block 130). In one embodiment, a TPM_CreateMigrationBlob command may be used to create the migratable blob.

Still referring to FIG. 2, the ticket granting agent may securely modify an authentication value of the migratable key (block 140). Such modification may be performed in a secure manner. In one embodiment, a TPM_ChangeAuth command may be sent from the ticket granting agent to the TPM of the mobile device to modify the authentication value.

In certain embodiments, to ensure that the key is not tampered with before the authentication value has changed, the ticket granting agent may perform one or more audits of the mobile device. For example, the ticket granting agent may audit the mobile device upon receipt of a ticket request to check actions performed on the TPM of the mobile device, ensuring that the user did not migrate the key to anyone else (including themselves). In one embodiment, a TPM_GetAuditEventSigned command may be used. A similar such audit may be performed by the remote ticket granting agent after changing the authorization value of the migratable key, in one embodiment using the same audit command as above. In other embodiments, other actions of the TPM may be audited to confirm security. After such audits are completed, the ticket granting agent can ensure that the key in the TPM was properly created, and only the ticket granting agent has access to the key itself. These properties may be guaranteed by the TPM. The ticket granting agent may then use this key to protect data and bind it to the TPM of the mobile device.

Next, the ticket granting agent may create an electronic ticket (block 150). The ticket may be created using the migratable key received from the TPM of the mobile device. In various embodiments, the ticket may be created such that upon delivery to the mobile device, it is bound to the TPM and is protected from modification and/or duplication. That is, access to the ticket may be restricted only to the user who requested the ticket and only upon compliance with certain conditions (e.g., time and place). Similarly, in embodiments relating to digital rights management, access to a token may be restricted to a given user and only upon compliance with conditions such as, for example, date and number of times the content may be accessed. In one embodiment, the ticket may be provided in three distinct parts: a ticket manifest; a ticket portion; and a ticket redemption stub.

The ticket manifest may be a non-redeemable ticket description, signed by the ticket granting agent, that describes what the actual ticket contains. This manifest may be accessed by a user of the mobile device, since the ticket itself is encrypted and may not be inspected by the user. In certain embodiments, the manifest may be signed in order to represent a legal contract that the actual ticket is equivalent to that which is represented in the manifest, and also to protect the manifest from unauthorized modification. The ticket itself may be signed by the ticket granting agent and encrypted using the key previously migrated to the ticket granting agent.

The ticket redemption stub may be used to authenticate the source of the TPM, and may contain the authentication value for the ticket key stored in the TPM, and a ticket identifier. In certain embodiments, the stub may also contain an AIK certificate that may be used to authenticate the TPM prior to ticket redemption. The ticket redemption stub may be encrypted with a public key of the ticket redemption agent, in certain embodiments. Alternately, a communication between a ticket granting agent and a ticket redemption agent may occur to verify that the ticket redemption stub is authentic.

Upon delivery to the mobile device, the electronic ticket may be bound to the TPM of the device (block 160). While the manner of such binding may vary in different embodiments, in one embodiment binding may occur in accordance with the TPM TCPA specification.

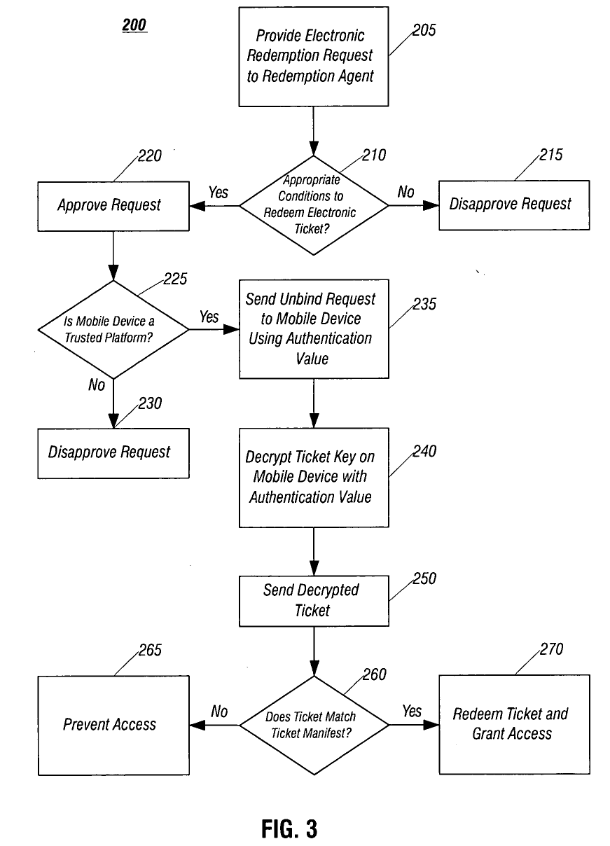

Referring now to FIG. 3, shown is a flow diagram of an electronic ticket redemption method in accordance with one embodiment of the present invention. As shown in FIG. 3, method 200 begins by providing an electronic redemption request to a redemption agent (block 205). For example, a user may begin the ticket redemption process by sending the ticket redemption stub and ticket manifest to the ticket redemption agent. In such manner, the manifest may act as a ticket claim by the device user, claiming that he holds the ticket described in the manifest. In one embodiment, the redemption request may be generated and sent by a mobile device, such as a 3G phone, a PDA or the like.

The redemption agent may first determine whether appropriate conditions exist to redeem the electronic ticket (diamond 210). For example, based on the ticket request for redemption, it may be determined whether appropriate time, date and/or location conditions have been met. If such conditions have not been met, the redemption agent may disapprove the request (block 215). If the conditions are met, the request may be approved (block 220).

Then the redemption agent may determine whether the mobile device that sent the request is a trusted platform (diamond 225). For example, the redemption agent may perform various checks or audits on data, keys and the like to determine that the mobile device contains an authentic TPM. In one embodiment authentication may proceed by requesting a TPM_Quote using a nonce value. In response, the TPM may produce the requested quote and send the quote information to the ticket redemption agent. If the agent believes the TPM is authentic based on checking the quote data, and the AIK used to sign the quote data is the same AIK as provided in the ticket redemption stub, then this confirms the TPM device that was issued the ticket is conversing with the redemption agent, and thus may be authenticated. If it is determined that the device is not authentic, the request may be disapproved (block 230).

If the device is approved, an unbind request may be sent to the mobile device using an authentication value (block 235). Specifically, in one embodiment the agent may construct a TPM_Unbind request using the authentication value retrieved from the decrypted ticket stub. The user may then decrypt the key using the authentication on the parent key, authenticating that the user is redeeming the key to the TPM. The TPM then decrypts the ticket using the authentication value and returns the decrypted ticket to the user (block 240). Next, the decrypted ticket key may be sent to the redemption agent (block 250).

Still referring to FIG. 3, the redemption agent may determine whether the ticket key matches the ticket manifest previously sent to the redemption agent (diamond 260). If there is no match, access may be prevented (block 265). If instead, the ticket key and the ticket manifest match, the ticket may be redeemed and access granted to the user of the mobile device (block 270).

In various embodiments, when the redemption agent provides a TPM_Unbind request to the TPM, the ticket may be considered redeemed and invalid for further use. This is because the ticket can be decrypted by the user once the TPM_Unbind request is issued. If the user decrypts the ticket and does not return it to the ticket redemption agent, it is possible to duplicate the ticket (because it is now decrypted). Thus by considering the ticket to be redeemed at this point prevents an early redemption attempt that does not return the ticket to the redemption agent, and then duplicates the ticket.

Thus, if a duplication attack is discovered, it can be shown that the user had to collude in such an attempt since the both the AIK used for the TPM_Quote and the user key that is the parent of the ticket key had to be accessed. Access to both these keys requires an authentication value known only to the user.

Embodiments may be implemented in a computer program. As such, these embodiments may be stored on a storage medium having stored thereon instructions which can be used to program a computer system to perform the embodiments. For example, one or more programs in accordance with an embodiment of the present invention may be stored in a trusted software stack (TSS), or other software supporting a TPM. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

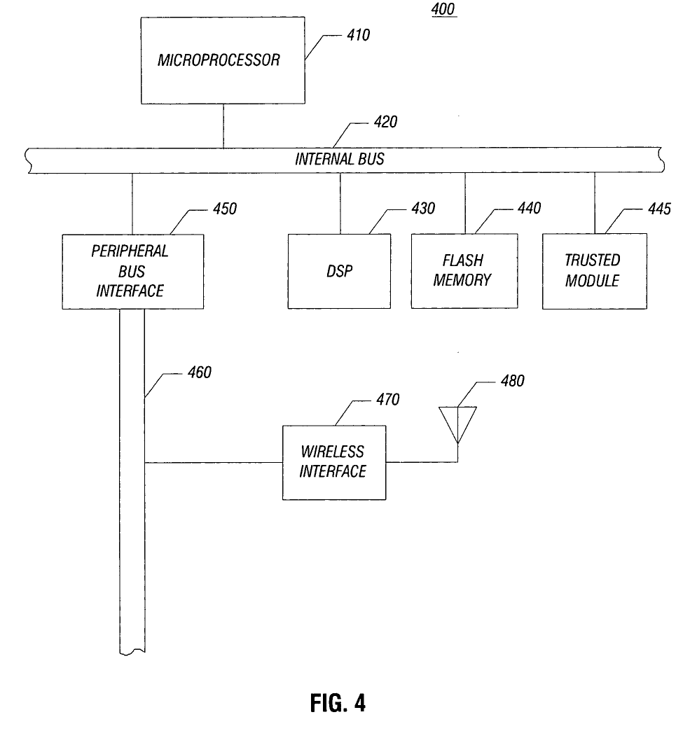

FIG. 4 is a block diagram of a mobile device with which embodiments of the invention may be used. As shown in FIG. 4, in one embodiment mobile device 400 includes a processor 410, which may include a general-purpose or special-purpose processor such as a microprocessor, microcontroller, application specific integrated circuit (ASIC), a programmable gate array (PGA), and the like. Processor 410 may be coupled to a digital signal processor (DSP) 430 via an internal bus 420. A flash memory 440 may be coupled to internal bus 420, and may execute remote binding applications in accordance with an embodiment of the present invention.

Also coupled to internal bus 420 may be a trusted module 445. In one embodiment, trusted module 445 may be permanently bonded to a motherboard of mobile device 400. Trusted module 445, which may be a general purpose processor, ASIC, or the like, may have basic so-called “smart card” capabilities. In certain embodiments, these capabilities may include cryptographic abilities such as keys, storage, signing, and encryption as set forth in the TCPA specification. In various embodiments, trusted module 445 may be used for attestation and sealing/unsealing of tokens.

While shown in FIG. 4 as a separate component, it is to be understood that in other embodiments trusted module 445 may be integrated with other components such as DSP 430, flash memory 440, and microprocessor 410. More so, in other embodiments, all such components may be integrated into a single device, such as a single semiconductor device. In such embodiments, storage controlled by trusted module 445 may be prevented from erasure to ensure that tokens and other secrets be maintained in a trusted state.

As shown in FIG. 4, microprocessor 410 may also be coupled to a peripheral bus interface 450 and a peripheral bus 460. While many devices may be coupled to peripheral bus 460, shown in FIG. 4 is a wireless interface 470 which is in turn coupled to an antenna 480. In various embodiments antenna 480 may be a dipole antenna, helical antenna, global system for mobile communication (GSM) or another such antenna.

In certain embodiments, wireless interface 470 may support General Packet Radio Services (GPRS) or another data service. GPRS may be used by wireless devices such as cellular phones of a 2.5G (generation) or later configuration. GPRS may be provided on existing time division multiple access (TDMA) or Global System for Mobile Communication (GSM) networks, for example. Other embodiments of the present invention may be implemented in a circuit switched network such as used by 2G technologies, a Personal Communications System (PCS) network, a Universal Mobile Telecommunications System (UMTS), or UMTS Telecommunications Radio Access (UTRA) network or other communication schemes, such as a BLUETOOTH™ protocol or an infrared protocol (such as Infrared Data Association (IrDA)).

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
binding a token to a device pursuant to a user request; and
preventing the user from unauthorized access to the token.

2. The method of claim 1, further comprising receiving the token at the device from a remote source after the remote source audits at least one activity of the device.

3. The method of claim 2, wherein the token comprises an electronic ticket having a manifest and a redemption stub.

4. The method of claim 3, further comprising providing the redemption stub to a redemption agent to obtain access to an activity.

5. The method of claim 1, further comprising binding the token to a trusted module after a remote source audits whether the trusted module provided a migratable key other than to the remote source.

6. A method comprising:
receiving an electronic ticket from a remote source; and
storing the electronic ticket in a user device so that a user cannot access the electronic ticket without authorization.

7. The method of claim 6, further comprising redeeming the electronic ticket to obtain access to an activity.

8. The method of claim 6, further comprising sending a migratable blob to the remote source, the migratable blob having a storage key associated therewith.

9. The method of claim 8, wherein receiving the electronic ticket comprises receiving the electronic ticket encrypted using the storage key.

10. The method of claim 9, further comprising providing status of the user device to the remote source pursuant to an audit request before receiving the electronic ticket.

11. The method of claim 6, further comprising preventing access to the electronic ticket until an unbind request is received from a redemption agent.

12. A method comprising:
providing an electronic ticket from a remote source to a user device, after auditing the user device to confirm no unauthorized event occurred on the user device.

13. The method of claim 12, further comprising providing the electronic ticket to the user device as an encrypted electronic ticket having a signature.

14. The method of claim 13, further comprising preventing modification or copying of the electronic ticket.

15. The method of claim 12, wherein the auditing comprising determining whether the user device exported a key to another source.

16. An article comprising a machine-readable storage medium containing instructions that if executed enable a system to:
bind a token to the system pursuant to a user request; and
prevent the user from unauthorized access to the token.

17. The article of claim 16, further comprising instructions that if executed enable the system to bind an electronic ticket having a manifest and a redemption stub.

18. The article of claim 17, further comprising instructions that if executed enable the system to provide the redemption stub to a redemption agent to obtain access to an activity.

19. The article of claim 16, further comprising instructions that if executed enable the system to bind the token to a trusted module of the system after a remote source audits whether the trusted module provided a migratable key other than to the remote source.

20. An apparatus comprising:
at least one storage device to store code to bind a token to the apparatus pursuant to a user request and prevent the user from unauthorized access to the token.

21. The apparatus of claim 20, further comprising a trusted module coupled to the at least one storage device.

22. The apparatus of claim 21, wherein the trusted module is coupled to receive the token from a remote source.

23. The apparatus of claim 20, wherein the at least one storage device comprises a flash memory.

24. The apparatus of claim 23, wherein the flash memory includes a trusted portion that cannot be erased.

25. A system comprising:
at least one storage device to store code to bind a token to the system pursuant to a user request and prevent the user from unauthorized access to the token; and
a wireless interface coupled to the at least one storage device.

26. The system of claim 25, further comprising a trusted module coupled to the at least one storage device.

27. The system of claim 25, wherein the wireless interface comprises an antenna.

28. The system of claim 25, wherein the at least one storage device further comprises code to provide status of the system to a remote source pursuant to an audit request before receiving the token.

29. The system of claim 25, wherein the at least one storage device further comprises code to provide the token to a redemption agent to obtain access to an activity.
